(19) United States
(12) Patent Application Publication
(10) Pub. No.: US 2019/0344609 A1
(43) Pub. Date: Nov. 14, 2019

(54) AIR TIGHT PAINT BRUSH AND ROLLER STORAGE CONTAINER

(71) Applicants: Palanikkumaran Muthiah, Sylvania, OH (US); Pravinabahen Parmar, Sylvania, OH (US)

(72) Inventors: Palanikkumaran Muthiah, Sylvania, OH (US); Pravinabahen Parmar, Sylvania, OH (US)

(21) Appl. No.: 16/410,358

(22) Filed: May 13, 2019

Related U.S. Application Data
(60) Provisional application No. 62/683,180, filed on Jun. 11, 2018.
(60) Provisional application No. 62/670,321, filed on May 11, 2018.

(51) Int. Cl. B44D 3/12

(52) U.S. Cl. CPC B44D 3/125

(57) ABSTRACT

A paint application container includes a first half and a second half. The first half includes an inner upper edge and an outer upper edge defining a continuous channel therebetween. The second half includes a continuous upper edge. The continuous upper edge of the second half aligns with and entirely fits within the continuous channel of the first half. A receptacle is defined in between the first half and the second half. The receptacle sized to fit a paint applicator therein. At least one clamp releasably couples the first half to the second half to hold the continuous upper edge within the continuous channel and create an air tight seal between the receptacle and outside air.

### CROSS-REFERENCE TO RELATED APPLICATION

This application claims the benefit of priority of U.S. provisional application No. 62/670,321, filed May 11, 2018, and U.S. provisional application No. 62/683,180, filed Jun. 11, 2018, the contents of which are herein incorporated by reference.

### BACKGROUND OF THE INVENTION

The present invention relates to paint brushes and rollers and, more particularly, to an air tight paint brush and paint roller storage container.

Wet paint brushes and paint rollers are difficult to store in-between breaks when a job is being performed, or between jobs, because the paint on brushes and rollers dry when exposed to air over a period of time, and cannot be reused.

Wet paint brushes and paint rollers are currently not stored, but manually cleaned between coats/breaks when required and between jobs for the next day. Manual cleaning of wet paint brush and paint roller is labor-intensive, inefficient, inconvenient and creates a messy process, damages the sensitive bristles and coating surfaces.

As can be seen, there is a need for an air tight paint brush and paint roller storage container.

### SUMMARY OF THE INVENTION

In one aspect of the present invention, a paint application container comprises: a first half comprising an inner upper edge and an outer upper edge defining a continuous channel therebetween; a second half comprising a continuous upper edge; and at least one clamp, wherein the continuous upper edge of the second half entirely fits within the continuous channel of the first half, a receptacle is defined in between the first half and the second half, the receptacle sized to fit a paint applicator therein, and the at least one clamp releasably couples the first half to the second half to hold the continuous upper edge within the continuous channel and create an air tight seal between the receptacle and outside air.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention in a closed position;

FIG. 2 is a side view of an embodiment of the present invention in a closed position;

FIG. 3 is a side view of an embodiment of the present invention in a closed position;

FIG. 4 is a top view of an embodiment of the present invention in a closed position;

FIG. 5 is a perspective view of a brush zip bag of an embodiment of the present invention;

FIG. 6 is a perspective view of an embodiment of the present invention in an opened position; and

FIG. 7 is a top view of an embodiment of the present invention in a closed position.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes an air tight wet paint brush storage device. This wet paint brush/roller storage box allows to preserve the wet paint brush/roller inside the box between coats and up to a month-time between jobs by providing air tight sealing. The present invention almost completely eliminates the messy manual cleaning process.

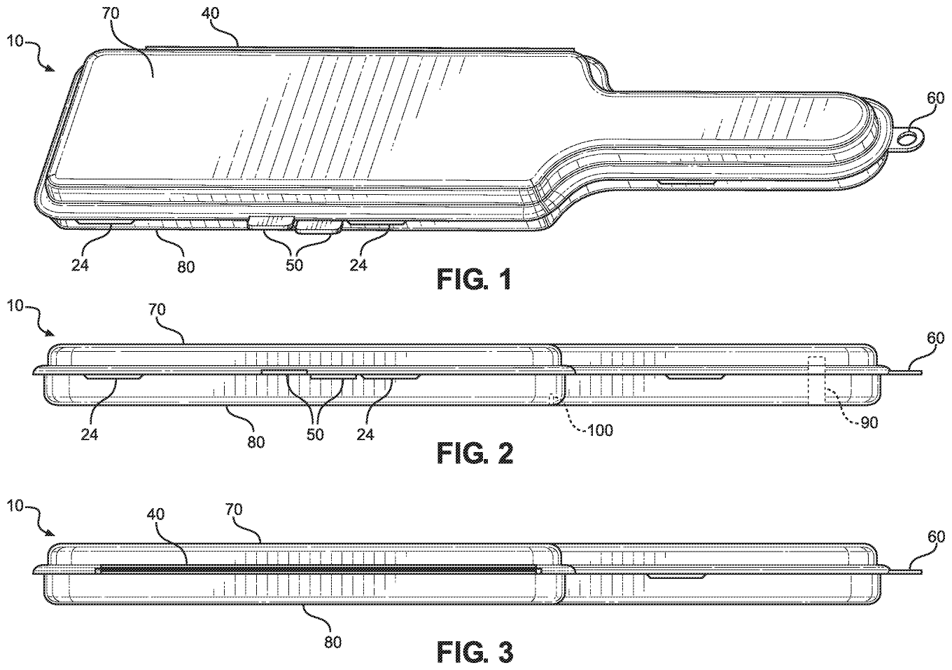

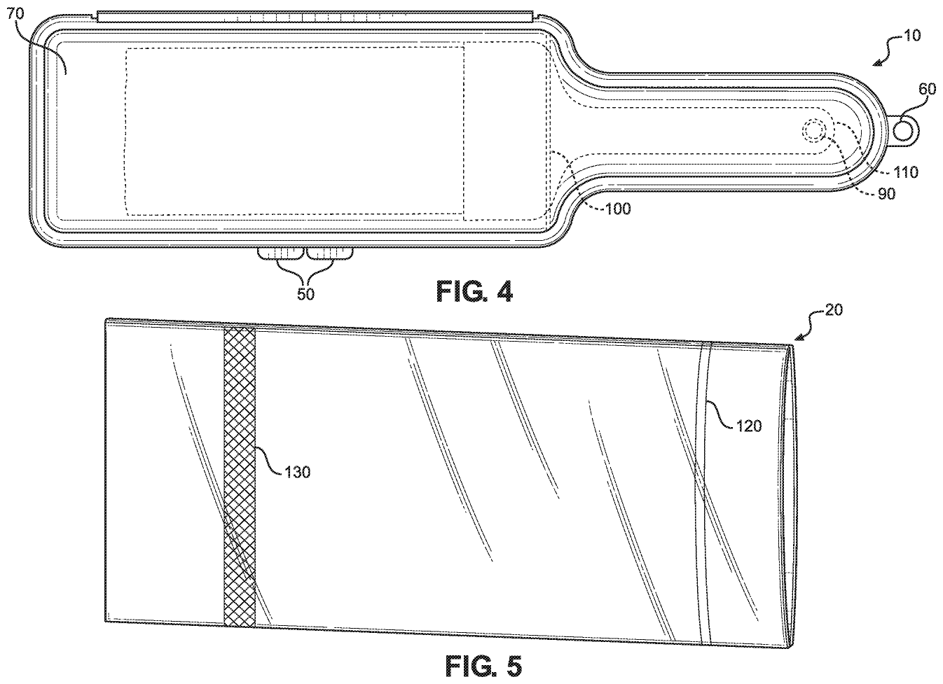

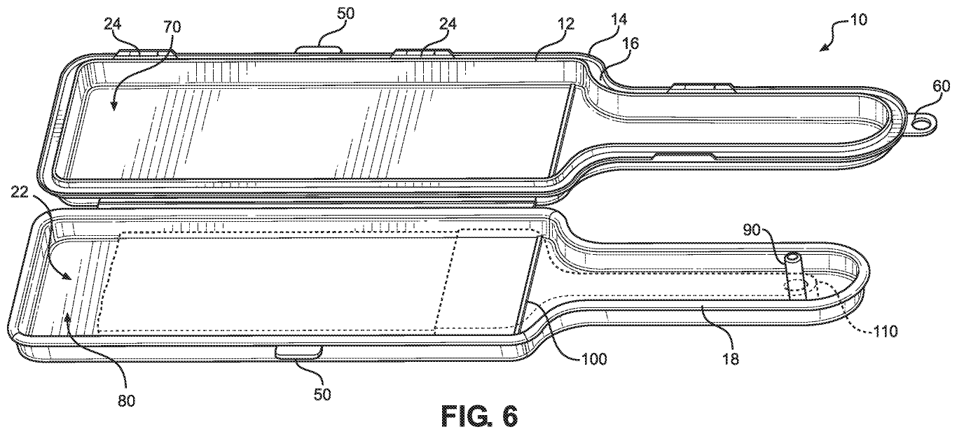

Referring to FIGS. 1 through 7, the present invention includes a paint application container 10. The paint application container 10 includes a first half 70 and a second half 80. The first half 70 includes an inner upper edge 12 and an outer upper edge 14 defining a continuous channel 16 therebetween. The second half 80 includes a continuous upper edge 18. The continuous upper edge 18 of the second half 80 aligns with and entirely fits within the continuous channel 16 of the first half 70. A receptacle 22 is defined in between the first half 70 and the second half 80. The receptacle 22 sized to fit a paint applicator 110, 140 therein.

At least one clamp 24 releasably couples the first half 70 to the second half 80 to hold the continuous upper edge 18 within the continuous channel 16 and create an air tight seal between the receptacle and outside air. The continuous upper edge 18 and the continuous channel 16 act as a male-female locking mechanism running continuously along the periphery to provide an air tight seal when the container 10 is closed.

In certain embodiments, each of the first half 70 and the second half 80 may include recessed inner surfaces defining the receptacle. In other embodiments, either the first half 70 or the second half 80 is substantially flat and acts as a lid and the other of the first half 70 and the second half 80 includes a recess to define the receptacle sized to receive the entire paint application 110, 140. In certain embodiments, each of the first half 70 and the second half 80 includes a wide head portion to fit the bristles of a paint brush 110 and a narrow handle portion to fit the handle of the paint brush 110. In other embodiments, the head portion and the handle portion have the same dimensions such that the container 10 has a rectangular cuboid shape.

In certain embodiments, the present invention may include a hinge 40 coupling the first half 70 and the second half 80 on a first side. In such embodiments, the clamp 24 releasably couples the first half 70 and the second half 80 on a second side, opposite the first side. The hinge 40 may be a living hinge, the hinge 40 pivotally connects the first half 70 to the second half 80 on the first side. Alternatively, the present invention may include a plurality of clamps 24 disposed about the perimeter and on the first and second sides of the container 10, in which a hinge 40 is not necessary.

The clamp 24 or clamps 24 may be any type of connector that holds the first half 70 against the second half 80, such as but not limited to latches, clasps, rubber bands, ties, and the like. As mentioned above, the clamp 24 may include a plurality of clamps 24 extending downward from the first half 70 at the head portion and the handle portion. Each of the clamps 24 may include a flexible barb that locks onto a flange formed by the upper continuous edge 18 of the second half 80 when a force is applied to urge the first half 70 against the second half 80. For example, the clamp 24 may be a latch similar to a cantilever with the flexible barb protruding inwards from the first half 70 to completely secure the container 10 after storing the brush 110. The clamps 24 provide a mechanical means to open and close the container 10 and access to paint brush 110. The present invention may further include handle tabs 50 extending from outer edges of the first half 70 and second half 80. Urging the handle tabs 50 together urges the plurality of clamps 24 to engage the flange. Urging the handle tabs 50 away from one another opens the container 10.

The present invention may further include rubber ribs 100 that accommodate the paint applicator 110, 140 at an incline within the container 10 to support the paint brush bristles. In such embodiments, a first rubber rib 100 extends from a first side to a second side of an inner surface of the first half 70 where the wide head portion meets the narrow handle portion. A second rubber rib 100 extends from a first side to a second side of an inner surface of the second half 80 where the wide head portion meets the narrow handle portion.

In certain embodiments, the present invention may include at least one peg 90 protruding from an inner surface of the second half 80 within the handle portion. The peg 90 may be a vertical post, which protrudes upwards to anchor the paint brushes 110 during storage. For example, the peg 90 may fit through an opening of the paint brush handle.

The present invention may further include a hanger tab 60 extending from the handle portion of the first half 70, second half 80, or bother. The hanger tab 60 includes an opening. The opening allows a user to hang the container 10 vertically with the bristles hanging downwards to maintain its shape during longer storage.

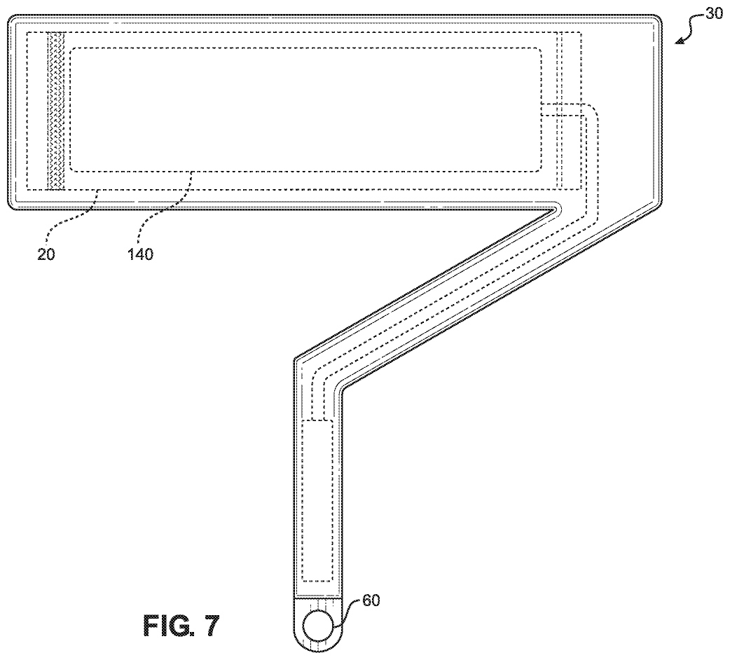

The paint application 110, 140 may include a paint brush 110 or a paint roller 140. For a paint brush 110, the container 10 may include an outer shape of a paint brush 110 and is sized to contain the paint brush 110 within. As illustrated in FIG. 7, for a paint roller 140, the container 30 may include an outer shape of a paint roller 140 and is sized to contain the paint roller 140 within.

As illustrated in FIG. 5, the present invention may further include a zip-lock polybag 20 with a tip portion/area to hold and insert the paint brushes and paint rollers, body area, a seal 130 between the body portion and bottom portion, and a bottom area. A weld seal 130 across polybag 20 width can be achieved preferably with heat or by synthetic adhesive or with a zipper. The body area receives wet paint brushes and paint rollers to contain paint dripping during storage. After storing the brush or roller, zipper lock 120 is applied to secure it, and placed over the storage container 10. For the next paint job, the bottom area is held with fingers and brush or roller is removed from the polybag 20.

The present invention is used to store wet paint brush/roller. This is provided by designing the container with top part (described above as “first half”) and bottom part (described above as “second half”), connecting the parts by means of hinge provision preferably located along partition line and at the center portion of the storage container, the hinge provides a convenient means to operate the box. The male-female design geometry running along the periphery of the container where top part and bottom part of the box meets provides an air tight seal to the container. This feature permits a means to store the wet paint brush inside the container and preserve it in wet conditions in-between painting jobs without drying the paint brush/roller and without damaging the bristles or sensitive coating surfaces. The choices with vertical posts, their locations, and box handle and body design allows storing paint brushes having different sizes and shapes. The design of ribs across from first side to second side on bottom part as well as on top part accommodate the paint applicator at an incline within the container to support the paint brush bristles.

The curved design around the box corners prevents any sharp turns and also provides an easy clean-up if required. The present invention and design geometry provide a means to store a variety of paint brushes having different sizes and shapes. This present invention also offers a complete air tight seal without any open area or stem within the box. Because with an open area and its requirements for a synthetic seal to cover it, cannot offer a complete air tight seal, and also synthetic seal gets damaged during its use that compromising the air tight seal design of the storage container. Therefore, with the present invention, wet paint brushes can be stored for longer time, and this present design provides a sturdy and durable container.

The wet paint brush/roller storage box may be made in one-step injection molded process, or multi-step film conversion and thermoforming process. A synthetic plastic resin is pressurized, melted, and injected into to a/multiple mold cavity of the die design to produce products. A mold design is to be carved first with allowable thickness tolerances for injection molding process, this allows one to produce storage box with bottom and top part, hinge, and box handle in one single step.

The present invention allows one to store wet paint brush/roller, so during its use, open the box, store the wet paint brush, and then securely close it to maintain the wet conditions of the brush. And for the next use, simply open the box and use the paint brush as it is in the preserved wet conditions. Variety of fields and technologies can adopt this invention. For example, industrial mixers, to be able to reuse between jobs, need a provision to store the mixers in an air tight storage container.

It should be understood, of course, that the foregoing relates to exemplary embodiments of the invention and that modifications may be made without departing from the spirit and scope of the invention as set forth in the following claims.

What is claimed is:

1. A paint application container comprising:
a first half comprising an inner upper edge and an outer upper edge defining a continuous channel therebetween;
a second half comprising a continuous upper edge; and
at least one clamp, wherein
the continuous upper edge of the second half entirely fits within the continuous channel of the first half,
a receptacle is defined in between the first half and the second half, the receptacle sized to fit a paint applicator therein, and
the at least one clamp releasably couples the first half to the second half to hold the continuous upper edge within the continuous channel and create an air tight seal between the receptacle and outside air.

2. The paint application container of claim 1, further comprising a hinge coupling the first half and the second half on a first side, wherein the at least one clamp releasably couples the first and the second half on a second side.

3. The paint application container of claim 1, wherein the clamp comprises a plurality of clamps extending downward from the first half and each comprising a flexible barb locking onto a flange of the second half when a force is applied to urge the first half against the second half.

4. The paint application container of claim 3, further comprising handle tabs extending from outer edges of the first half and second half, wherein urging the handle tabs together urges the plurality of clamps to engage the flange.

5. The paint application container of claim 1, wherein each of the first half and the second half comprise a recessed inner surface defining the receptacle.

6. The paint application container of claim 1, wherein each of the first half and the second half comprise a wide head portion and a narrow handle portion.

7. The paint application container of claim 6, further comprising a first rubber rib extending from a first side to a second side of an inner surface of the first half where the wide head portion meets the narrow handle portion, and a second rubber rib extending from a first side to a second side of an inner surface of the second half where the wide head portion meets the narrow handle portion.

8. The paint application container of claim 6, further comprising a peg protruding from an inner surface of the second half within the handle portion.

9. The paint application container of claim 6, further comprising a hanger tab extending from the handle portion of the first half, the hanger tab comprising an opening.

10. The paint application container of claim 1, wherein the paint applicator is a paint brush or a paint roller.
